(19) United States
(12) Patent Application Publication
(10) Pub. No.: US 2023/0364837 A1
(43) Pub. Date: Nov. 16, 2023

(54) Method and Mold Assembly for Forming a Mat

(71) Applicant: Pei-Huang Liao, Tainan City (TW)

(72) Inventor: Pei-Huang Liao, Tainan City (TW)

(21) Appl. No.: 17/744,840

(22) Filed: May 16, 2022

(51) Int. Cl. B29C 45/14

(52) U.S. Cl. CPC B29C 45/14336; B29C 45/14065; B29C 2045/14122

(57) ABSTRACT

A method for forming a mat includes forming a fixer made of a rigid material. The fixer includes a central portion which is cylindrical and which includes an annular wall having two ends opposite to each other. A mold assembly is provided for forming the mat. The fixer is disposed in the mold assembly in an open state. The mold assembly is closed, and a soft plastic material for forming the mat is filled into the mold assembly. The soft plastic material envelopes a peripheral portion of the central portion of the fixer. Then, the mold assembly is opened to remove the mat and the fixer which are fixed together.

### BACKGROUND OF THE INVENTION

The present invention relates to a method and a mold assembly for forming a mat and, more particularly, to a method and a mold assembly providing better assembling stability to prevent the fixer from shifting.

A conventional mat is made of soft plastic material to provide comfort stepping. A rigid fixer is disposed on the mat and includes a coupling hole for reliably coupling with a rigid hook on a vehicle carpet.

FIGS. 8 and 9 show a conventional mat 1′ and a conventional fixer 2′. The mat 1′ is soft and includes a through-hole 11′ for the fixer 2′. The fixer 2′ is rigid includes an upper coupling block 21′ and a lower coupling block 22′. Each of the upper and lower coupling blocks 21′ and 22′ includes a central portion having a coupling hole 211′, 221′ and a coupling wall 212′, 222′. The upper and lower coupling blocks 21′ and 22′ are respectively disposed on top and bottom sides of the mat 1′ and are aligned with the through-hole 11′. Then, the upper and lower coupling blocks 21′ and 22′ are tightly coupled via the coupling walls 212′ and 222′. The rigid fixer 2′ can be fixed to the soft mat 1′. The coupling holes 211′ and 221′ can be coupled with a hook (not shown) of a vehicle body to provide better assembly application and safety.

When a user steps on the mat 1′ and touches the fixer 2′ or pulls the mat 1′, the upper and lower coupling blocks 21′ and 22′ are apt to disengage from each other. The resistance to pulling force is insufficient, and the assembling stability is not good. Furthermore, during manufacture, the upper and lower coupling blocks 21′ and 22′ and the mat 1′ are formed separately and then assembled, which is inconvenient to assemble and which causes an increase in the manufacturing costs.

### BRIEF SUMMARY OF THE INVENTION

An objective of the present invention is to provide a method and a mold assembly for forming a mat to provide better assembling stability and to prevent shifting of a fixer during formation of the mat.

A method for forming a mat according to the present invention comprises the following steps:
forming a fixer made of a rigid material, wherein the fixer includes a central portion which is cylindrical and which includes an annular wall having two ends opposite to each other;
providing a mold assembly for forming the mat, wherein the fixer is disposed in the mold assembly in an open state;
closing the mold assembly and filling a soft plastic material for forming the mat into the mold assembly, wherein the soft plastic material envelopes a peripheral portion of the central portion of the fixer; and
opening the mold assembly and removing the mat and the fixer which are fixed together.

In an example, the annular wall includes a coupling hole at an inner side thereof. The coupling hole is elongated. The mold assembly includes a protrusion. The protrusion is elongated and extends through the coupling hole of the fixer to fix an angular position of the fixer.

In an example, the mold assembly includes:
a first male mold including a first mold cavity configured to receive the soft plastic material for forming the mat;
a first female mold configured to couple with the first male mold, wherein the first female mold includes a second mold cavity configured to receive the soft plastic material for forming the mat;
at least one second male mold disposed in the first male mold and located on a position corresponding to the fixer, wherein the at least one second male mold is integrally formed with or separable from the first male mold; and
at least one second female mold disposed in the first female mold and located on a position corresponding to the fixer, wherein the at least one second female mold is integrally formed with or separable from the first female mold, and wherein the protrusion is disposed on a central position of an end of the at least one second female mold.

In an example, the first male mold includes at least one first receiving groove. The at least one second male mold is securely disposed in the at least one first receiving groove. The first female mold includes at least one second receiving groove. The at least one second female mold is securely disposed in the at least one second receiving groove.

In an example, the fixer includes a coupling wall extending radially outward from the annular wall. The coupling wall includes at least one positioning hole. The at least one second female mold includes at least one positioning rod extending through the at least one positioning hole.

In an example, the at least one second female mold includes an end having a groove slightly larger than one of the two ends of the annular wall of the central portion of the fixer. The protrusion is disposed in the groove.

In an example, the at least one second female mold includes at least one slot. The at least one positioning rod extends through the at least one slot. An end of the positioning rod protrudes beyond the at least one second female mold.

In an example, the fixer is located between the at least one second male mold and the at least one second female mold when the at least one second male mold and the at least one second female mold are in a closed state. The at least one second male mold and the at least one second female mold have a space therebetween for receiving the coupling wall and the soft plastic material. The space is around the central portion of the fixer.

In an example, the at least one second male mold includes an end having an annular groove fittingly receiving one of the two ends of the annular wall of the central portion of the fixer. The coupling wall of the fixer includes at least one engaging hole through which the soft plastic material extends.

When carrying out formation of the mat according to the present invention, the fixer is placed on the at least one second female mold, and the coupling hole is coupled with the elongated protrusion of the at least one second female mold to fix an angular position of the coupling hole. Furthermore, the insertion end of the at least one positioning rod extends through the respective positioning hole for positioning purposes. The protrusion in the central portion and the at least one positioning rod in the peripheral portion provide a double positioning effect, providing better positioning stability. Then, the first male mold and the first female mold are closed. The annular groove of the at least one second male mold fittingly receives one of the two ends of the annular wall of the central portion of the fixer for positioning purposes. Then, the soft plastic material for forming the mat is filled into the space. The soft plastic material envelopes the coupling wall of the fixer and extends through the engaging hole, providing improved assembling stability. During the filling procedure, the central portion and the peripheral portion of the fixer are secured by the coupling hole and the protrusion and by the at least one positioning rod and the respective positioning hole, respectively, assuring the fixer from shifting, thereby improving the formation stability.

The present invention will become clearer in light of the following detailed description of illustrative embodiments of this invention described in connection with the drawings.

### DESCRIPTION OF THE DRAWINGS

FIG. 1 is an exploded perspective view of a mold assembly and a fixer according to the present invention.

FIG. 1A is an enlarged view of a circled portion of FIG. 1.

FIG. 1B is an enlarged view of another circled portion of FIG. 1.

FIG. 1C is an enlarged view of a further circled portion of FIG. 1.

FIG. 2 is a partial, cross sectional view of first and second male molds and first and second female molds of the mold assembly according to the present invention.

FIG. 3 is a partial, perspective view illustrating the fixer disposed in the second female mold according to the present invention.

FIG. 4 is a cross sectional view illustrating the fixer disposed in the second female mold according to the present invention.

FIG. 5 is a cross sectional view illustrating the mold assembly according to the present invention in a closed state.

FIG. 6 is a cross sectional view illustrating molding injection in the mold assembly according to the present invention.

FIG. 7 is an exploded, cross sectional view illustrating opening of the mold assembly according to the present invention.

FIG. 8 is a partial, exploded, perspective view of a conventional mat and a conventional fixer.

FIG. 9 is a partial, cross sectional view of the conventional mat and the conventional fixer.

### DETAILED DESCRIPTION OF THE INVENTION

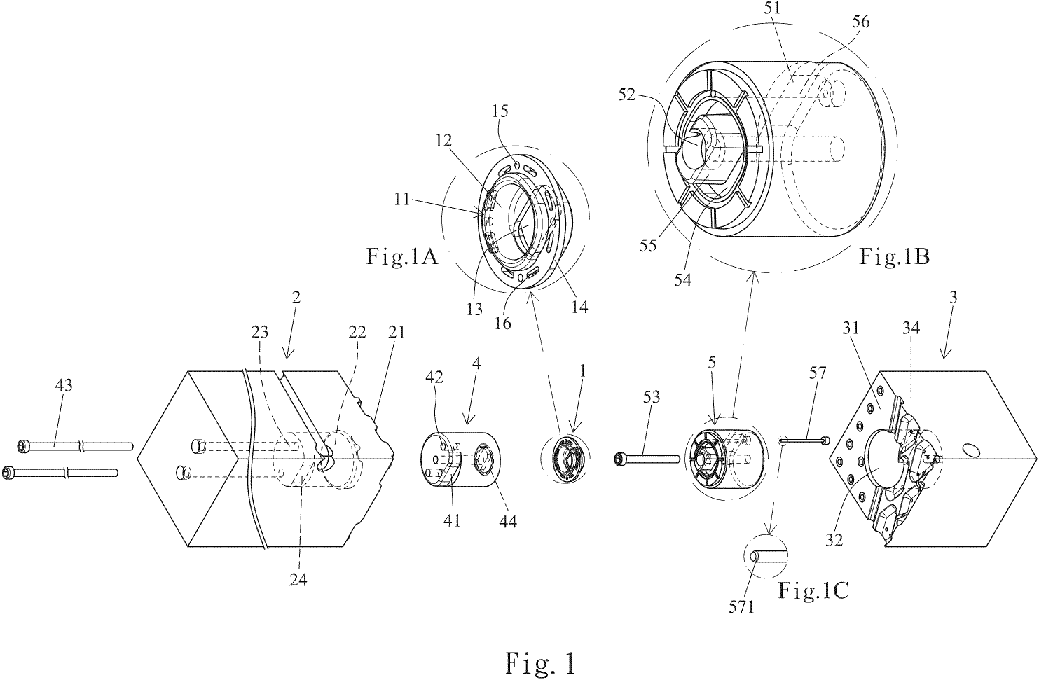

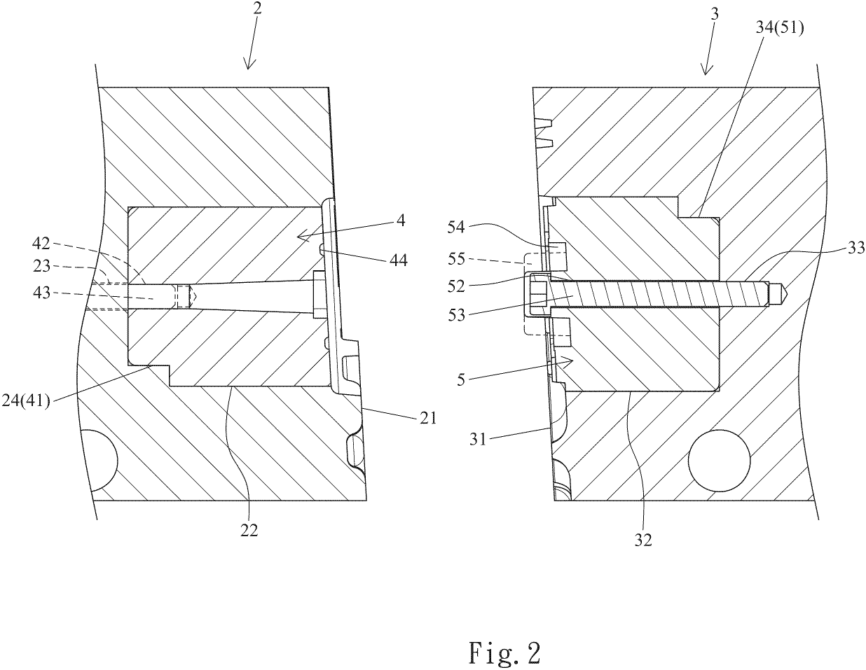

With reference to FIGS. 1-5, the present invention comprises at least one fixer 1, a first male mold 2, a first female mold 3, at least one second male mold 4, and at least one second female mold 5. The first male mold 2 and the first female mold 3 can be used to form a complete mat. The drawings illustrate a portion of the structure. The fixer 1 is made of a rigid material and includes a central portion 11 which is cylindrical and which includes an annular wall 12 having two ends opposite to each other. The annular wall 12 includes a coupling hole 13 at an inner side thereof. The coupling hole 13 may be elongated. The fixer 1 includes a coupling wall 14 extending radially outward from the annular wall 12. The coupling wall 14 includes at least one positioning hole 15 and a plurality of engaging holes 16. In this embodiment, the coupling wall 14 includes four positioning holes 15. In other embodiments, different numbers of positioning holes 15 may be disposed. A current vehicle body generally includes two hooks (not shown). The present invention may comprise two fixers 1, and only one fixer 1 is shown in the drawings.

The first male mold 2 includes a first mold cavity 21 configured to receive the soft plastic material for forming the mat. The first mold cavity 21 includes at least one first receiving groove 22 in a position corresponding to the at least one fixer 1. Since a current vehicle generally includes two hooks (not shown), and the first mold cavity 21 includes two first receiving grooves 22. The drawings illustrate one first receiving groove 22. Furthermore, the first receiving groove 22 includes assembling holes 23 and a first wall protrusion 24.

The first female mold 3 is configured to couple with the first male mold 2. The first female mold 3 includes a second mold cavity 31 configured to receive the soft plastic material for forming the mat. The second mold cavity 31 includes at least one second receiving groove 32 in a position corresponding to the at least one fixer 1. Since a current vehicle body generally includes two hooks (not shown), the second mold cavity 31 may include two second receiving grooves 32. The drawings illustrate one second receiving groove 32. Furthermore, the second receiving groove 32 includes an assembling hole 33 and a second wall protrusion 34.

The at least one second male mold 4 is securely disposed in the at least one first receiving groove 22 and includes a first wall recess 41 in a position corresponding to the first wall protrusion 24. The at least one second male mold 4 further includes assembling holes 42. The at least one second male mold 4 is placed into the at least one first receiving groove 22, and fasteners 43 extend through the assembling holes 42 and 23 of the at least one second male mold 4 and the at least one first receiving groove 22 for fixing purposes. Furthermore, the first wall recess 41 fittingly abuts the first wall protrusion 24 to reliably avoid the at least one second male mold 4 from rotating in the at least one first receiving groove 22. Furthermore, the at least one second male mold 4 includes an end having an annular groove 44 fittingly receiving one of the two ends of the annular wall 12 of the central portion 11 of the at least one fixer 1. In a case that the first male mold 2 has two first receiving grooves 22, two second male molds 4 are provided. In another embodiment, the at least one second male mold 4 can be integrally formed with the first male mold 2.

The at least one second female mold 5 is securely disposed in the at least one second receiving groove 32 and includes a second wall recess 51 corresponding to the second wall protrusion 34. The at least one second female mold 5 is placed into the at least one second receiving groove 32, and a fastener 53 extends through the assembling holes 52 and 33 of the at least one second female mold 5 and the at least one second receiving groove 32 for fixing purposes. Furthermore, the second wall recess 51 fittingly abuts the second wall protrusion 34 to reliably avoid the at least one second female mold 5 from rotating in the at least one second receiving groove 32.

The at least one second female mold 5 includes an end having a groove 54 slightly larger than one of the two ends of the annular wall 12 of the central portion 11 of the at least one fixer 1. A central portion of the groove 54 has a protrusion 55 that may be elongated. The protrusion 55 can extend through the elongated coupling hole 13 of the at least one fixer 1. The at least one second female mold 5 includes at least one slot 56 on a location corresponding to a respective positioning hole 15 of the at least one fixer 1. At least one positioning rod 57 extends through the at least one slot 56 and the respective positioning hole 15. An end of the at least one positioning rod 57 protrudes beyond the at least one second female mold 5. The at least one positioning rod 57 includes a conic insertion end 571 having decreasing diameters towards the respective positioning hole 15. This embodiment includes a slot 56 and a positioning rod 57. In other embodiments, two to four slots 56 and a corresponding number of positioning rods 57 can be provided on locations corresponding to the respective positioning holes 15 to improve the positioning stability (not shown). In this embodiment, the positioning rod 57 and the at least one second female mold 5 can be separate from each other and can be assembled to permit easy replacement when the insertion end 571 of the positioning rod 57 is worn out. In a case that the first female mold 3 has two second receiving grooves 32, two second female molds 5 are provided. In another embodiment, the at least one second female mold 5 and the first female mold 3 may be integrally formed.

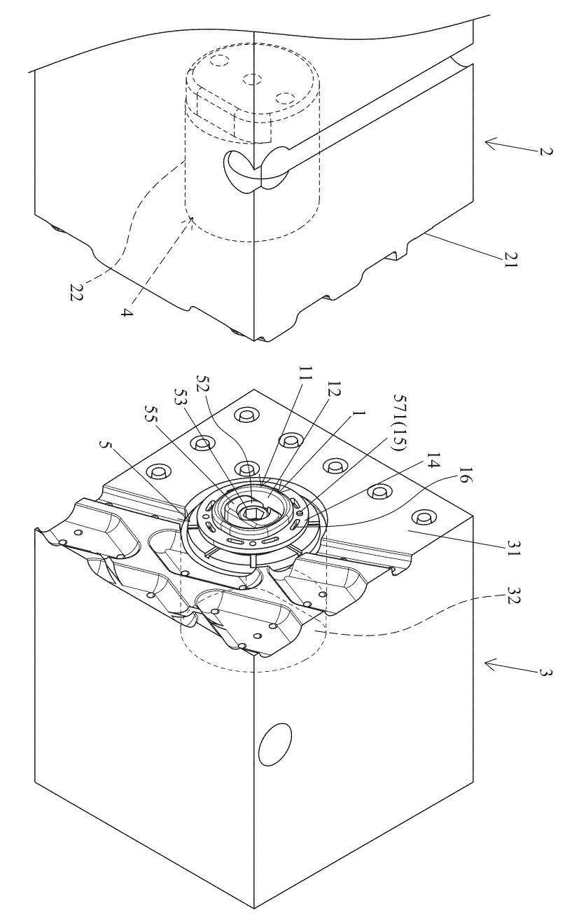

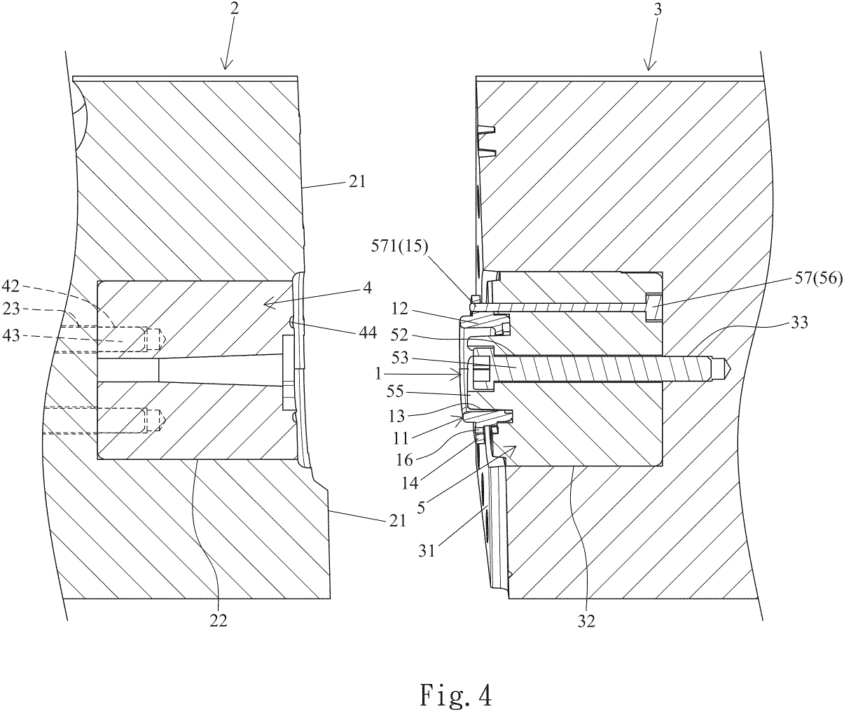

When carrying out formation of the mat according to the present invention, the first male mold 2 and the first female mold 3 are opened. As shown in FIGS. 3 and 4, the at least one fixer 1 is placed on the at least one second female mold 5, and the coupling hole 13 is coupled with the elongated protrusion 55 of the at least one second female mold 5 to fix an angular position of the coupling hole 13. Furthermore, the insertion end 571 of the at least one positioning rod 57 extends through the respective positioning hole 15, and the conic shape of the insertion end 571 provides better insertion convenience. After disposition of the at least one fixer 1, the protrusion 55 in the central portion and the at least one positioning rod 57 in the peripheral portion provide a double positioning effect to prevent the at least one fixer 1 from shifting relative to the at least one second female mold 5, providing better positioning stability.

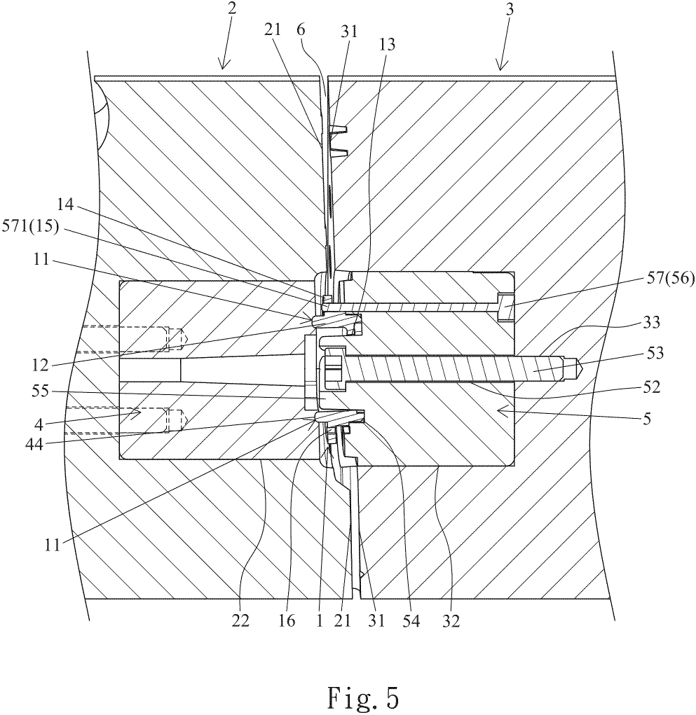

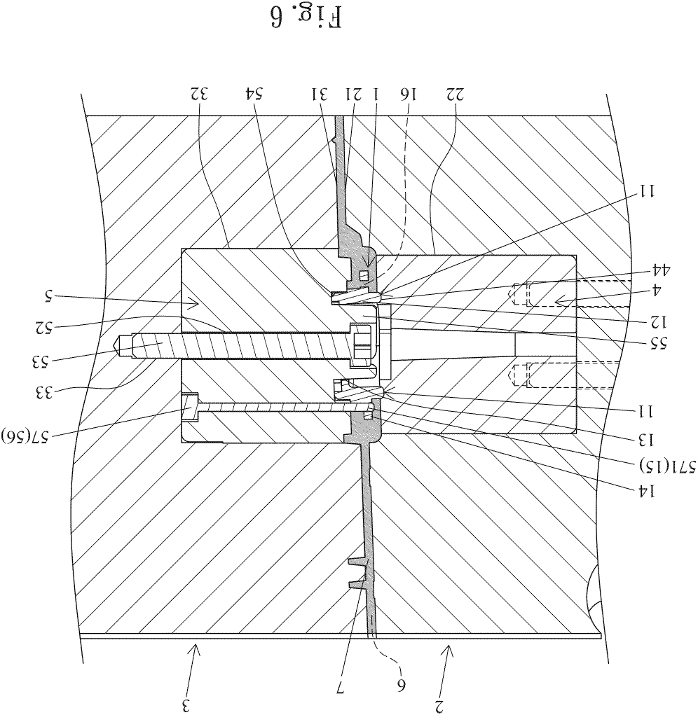

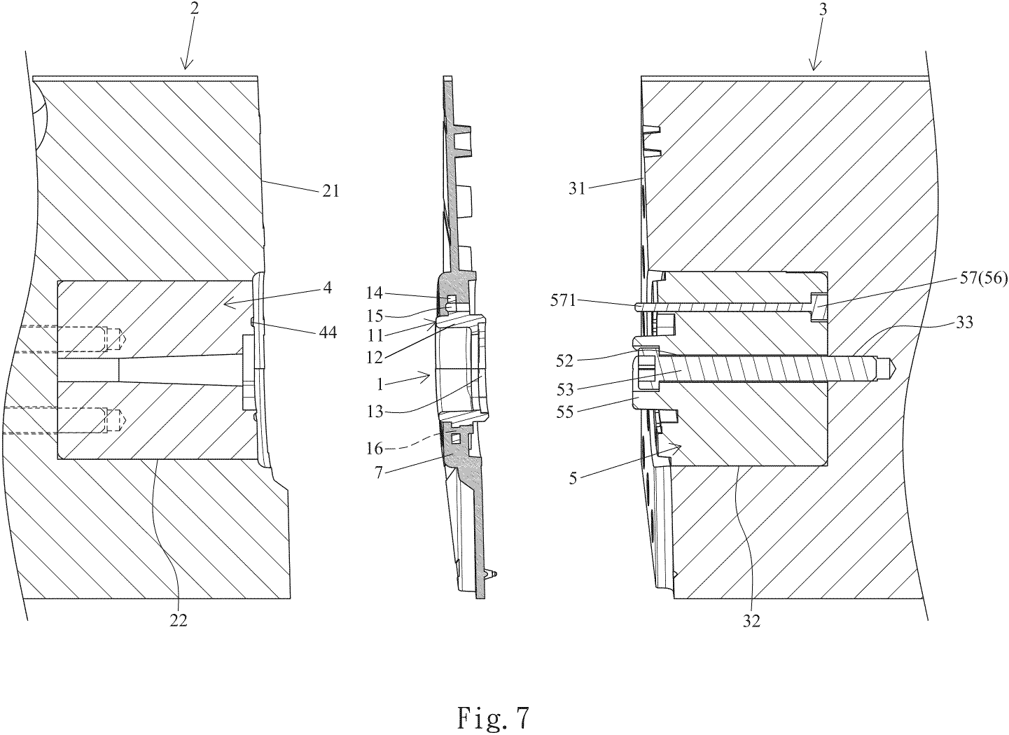

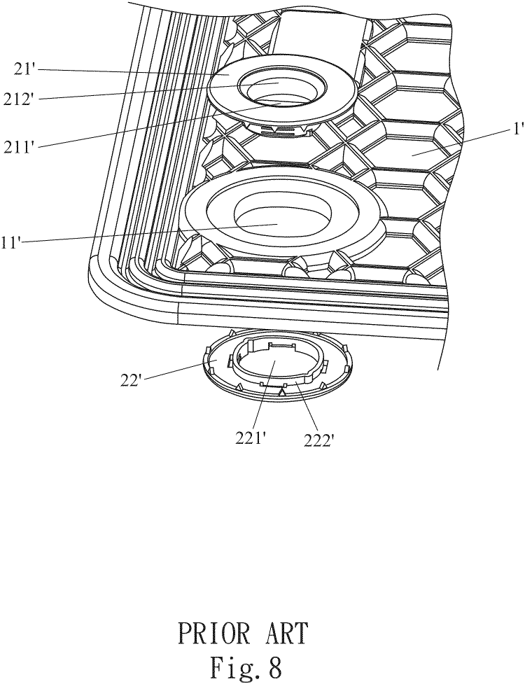

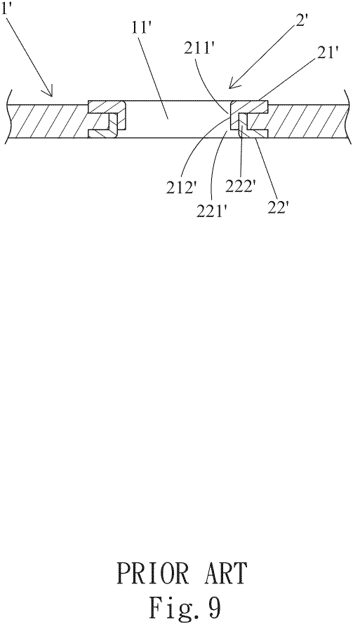

After the at least one fixer 1 is disposed in the at least one second female mold 5, the first male mold 2 and the first female mold 3 are closed, as shown in FIG. 5. Furthermore, the at least one second male mold 4 and the at least one female mold 5 have a space 6 therebetween for receiving the coupling wall 14 and the soft plastic material. The space 6 is around the central portion 11 of the at least one fixer 1. The annular groove 44 at the end of the at least one second male mold 4 fittingly receives one of the two ends of the annular wall 12 of the central portion 11 of the at least one fixer 1 for positioning purposes. Then, the soft plastic material 7 is filled into the space 6, as shown in FIG. 6. The soft plastic material 7 envelopes the coupling wall 14 of the at least one fixer 1 and extends through the plurality of engaging holes 16. During the filling procedure, the central portion and the peripheral portion of the at least one fixer 1 are secured by the coupling hole 13 and the protrusion 55 and by the at least one positioning rod 57 and the respective positioning hole 15, respectively, assuring the at least one fixer 1 from shifting, thereby improving the formation stability. After formation, the first male mold 2 and the at least one second male mold 4 are opened to remove the product of the mat.

Since the longitudinal direction of the coupling hole 13 of the at least one fixer 1 of the final product produced according to the present invention can be securely positioned relative to the left/right direction of a vehicle body, the mat will not shift in the front/rear direction and/or the left/right direction after the coupling hole 13 engages with an elongated hook of the vehicle body, providing improved safety. Furthermore, the mat can be adjusted in the left/right direction due to provision of the elongated coupling hole 13, providing improved installation convenience. Furthermore, the at least one fixer 1 is difficult to disengage from the soft plastic material 7 of the mat after formation, improving the resistance to pulling. This avoids disengagement of the upper and lower coupling blocks of the conventional fixer due to stepping, providing better assembling stability and reliability.

In view of the foregoing, the present invention can improve the assembling reliability of the fixer 1 disposed on the mat and can avoid shifting of the fixer 1 during formation, providing improved use safety and reliability. In a case that the positioning rod 57 is not used, the protrusion 55 and the coupling hole 13 can provide sufficient positioning stability.

Although specific embodiments have been illustrated and described, numerous modifications and variations are still possible without departing from the scope of the invention. The scope of the invention is limited by the accompanying claims.

1. A method for forming a mat, comprising the steps of:
forming a fixer made of a rigid material, wherein the fixer includes a central portion which is cylindrical and which includes an annular wall having two ends opposite to each other;
providing a mold assembly for forming the mat, wherein the fixer is disposed in the mold assembly in an open state,
closing the mold assembly and filling a soft plastic material for forming the mat into the mold assembly, wherein the soft plastic material envelopes a peripheral portion of the central portion of the fixer; and
opening the mold assembly and removing the mat and the fixer which are fixed together,
wherein the annular wall includes a coupling hole at an inner side thereof, wherein the coupling hole is elongated, wherein the mold assembly includes a protrusion, and wherein the protrusion is elongated and extends through the coupling hole of the fixer to fix an angular position of the fixer,
wherein the mold assembly includes:
a first male mold including a first mold cavity configured to receive the soft plastic material for forming the mat;
a first female mold configured to couple with the first male mold, wherein the first female mold includes a second mold cavity configured to receive the soft plastic material for forming the mat;
at least one second male mold disposed in the first male mold and located on a position corresponding to the fixer, wherein the at least one second male mold is integrally formed with or separable from the first male mold; and
at least one second female mold disposed in the first female mold and located on a position corresponding to the fixer, wherein the at least one second female mold is integrally formed with or separable from the first female mold, and wherein the protrusion is disposed on a central position of an end of the at least one second female mold,
wherein the first male mold includes at least one first receiving groove, wherein the at least one second male mold is securely disposed in the at least one first receiving groove, wherein the first female mold includes at least one second receiving groove, and wherein the at least one second female mold is securely disposed in the at least one second receiving groove,
wherein the fixer includes a coupling wall extending radially outward from the annular wall, wherein the coupling wall includes at least one positioning hole, wherein the at least one second female mold includes at least one positioning rod extending through the at least one positioning hole,
wherein the at least one second female mold includes an end having a groove slightly larger than one of the two ends of the annular wall of the central portion of the fixer, and wherein the protrusion is disposed in the groove, and
wherein the at least one second female mold further includes at least one slot, wherein the at least one positioning rod extends through the at least one slot, and wherein an end of the positioning rod protrudes beyond the at least one second female mold.

2-7. (canceled)

8. The method for forming the mat as claimed in claim 1, wherein the fixer is located between the at least one second male mold and the at least one second female mold when the at least one second male mold and the at least one second female mold are in a closed state, wherein the at least one second male mold and the at least one second female mold have a space therebetween for receiving the coupling wall and the soft plastic material, and wherein the space is around the central portion of the fixer.

9. The method for forming the mat as claimed in claim 1, wherein the at least one second male mold includes an end having an annular groove fittingly receiving one of the two ends of the annular wall of the central portion of the fixer.

10. The method for forming the mat as claimed in claim 1, wherein the coupling wall of the fixer includes at least one engaging hole through which the soft plastic material extends.

11. A combination comprising:
at least one fixer made of a rigid material, wherein the at least one fixer includes a central portion which is tubular and which includes an annular wall having two ends opposite to each other, wherein the annular wall includes a coupling hole at an inner side thereof, wherein the coupling hole is elongated;
a first male mold including a first mold cavity configured to receive the soft plastic material for forming the mat;
a first female mold configured to couple with the first male mold, wherein the first female mold includes a second mold cavity configured to receive the soft plastic material for forming the mat;
at least one second male mold disposed in the first male mold and located on a position corresponding to the at least one fixer, wherein the at least one second male mold is integrally formed with or separable from the first male mold; and
at least one second female mold disposed in the first female mold and located on a position corresponding to the at least one fixer, wherein the at least one second female mold is integrally formed with or separable from the first female mold, wherein a protrusion is disposed on a central position of an end of the at least one second female mold, and wherein the protrusion is elongated and extends through the coupling hole of the fixer to fix an angular position of the fixer.

12. The combination as claimed in claim 11, wherein the first male mold includes at least one first receiving groove, wherein the at least one second male mold is securely disposed in the at least one first receiving groove, wherein the first female mold includes at least one second receiving groove, and wherein the at least one second female mold is securely disposed in the at least one second receiving groove.

13. The combination as claimed in claim 12, wherein the fixer includes a coupling wall extending radially outward from the annular wall, wherein the coupling wall includes at least one positioning hole, wherein the at least one second female mold includes at least one positioning rod extending through the at least one positioning hole.

14. The combination as claimed in claim 12, wherein the at least one second female mold includes an end having a groove slightly larger than one of the two ends of the annular wall of the central portion of the at least one fixer, and wherein the protrusion is disposed in the groove.

15. The combination as claimed in claim 13, wherein the at least one second female mold includes at least one slot, wherein the at least one positioning rod extends through the at least one slot, and wherein an end of the positioning rod protrudes beyond the at least one second female mold.

16. The combination as claimed in claim 12, wherein the at least one fixer is located between the at least one second male mold and the at least one second female mold when the at least one second male mold and the at least one second female mold are in a closed state, wherein the at least one second male mold and the at least one second female mold have a space therebetween for receiving the coupling wall and the soft plastic material, and wherein the space is around the central portion of the at least one fixer.

17. The combination as claimed in claim 12, wherein the at least one second male mold includes an end having an annular groove fittingly receiving one of the two ends of the annular wall of the central portion of the at least one fixer.

18. The combination as claimed in claim 13, wherein the coupling wall of the at least one fixer includes at least one engaging hole through which the soft plastic material extends.
